(19) United States
(12) Patent Application Publication
(10) Pub. No.: US 2019/0333007 A1
(43) Pub. Date: Oct. 31, 2019

(54) SYSTEMS AND METHODS FOR PRESENTING INFORMATION ON DIGITAL INVENTORY PREPARATION LABELS

(71) Applicant: Walmart Apollo, LLC, Bentonville, AR (US)

(72) Inventors: Donald R. High, Noel, MO (US); John C. Crecelius, JR., Springdale, AR (US); Matthew A. Jones, Bentonville, AR (US); Nicholaus A. Jones, Fayetteville, AR (US); Robert J. Taylor, Rogers, AR (US)

(21) Appl. No.: 16/397,646

(22) Filed: Apr. 29, 2019

Related U.S. Application Data
(60) Provisional application No. 62/664,423, filed on Apr. 30, 2018.

(51) Int. Cl. G06Q 10/08; G09F 3/20; G06Q 20/20

(52) U.S. Cl. CPC G06Q 10/087; G06Q 20/203; G09F 3/208

(57) ABSTRACT

In some embodiments, apparatuses and methods are provided herein useful to presenting information on an DIPL. In some embodiments, a system for presenting information on an DIPL comprises the DIPL including a display device configured to present information related to an action to perform with a package, a wireless radio, and a securement mechanism configured to removably secure the DIPL to the package, and a control circuit configured to receive identification information for the DIPL and information for the package, associate, in a database, the identification information for the DIPL and the information for the package, determine the action to perform based on information associated with inventory levels in a retail facility, determine that the package is required for the action, and transmit, to the DIPL for presentation via the display device of the DIPL, an indication of the information related to the action to perform with the package.

### CROSS-REFERENCE TO RELATED APPLICATION

This application claims the benefit of U.S. Provisional Application No. 62/664,423, filed Apr. 30, 2018, which is incorporated by reference in its entirety herein.

### TECHNICAL FIELD

This invention relates generally to inventory management and, more specifically, to automated inventory management.

### BACKGROUND

Inventory management is important to a retailer for many reasons. For example, an accurate understanding of a retail facility's inventory is useful in planning orders, detecting and reducing theft, maintaining stocked shelves, etc. Consequently, proper inventory management aids in maximizing profitability. Many retailers have hundreds, if not thousands, of products in a retail facility at any given time. Keep tracking of such a vast number of products poses many challenges. As part of their inventory management, retailers attempt to inventory all products in a retail facility (e.g., all products on sales floor, in a stockroom, and/or being delivered). Currently, retailers keep track of inventory by manually evaluating inventory levels. For example, a retailer may have employees scan all products in a stock room on a daily, weekly, monthly, etc. basis. While such manual assessment may provide fairly accurate inventory levels, such manual scanning is difficult, time consuming, and costly. Additionally, since manual assessment of inventory cannot provide inventory analysis in real or near real time, there is often a lag between a determination that products need to be moved from the stockroom to the salesfloor. Such a lag may result in lost sales if a customer cannot find a product for which he or she is looking because the product is in the stockroom and not on the sales floor. Accordingly, a need exists for superior inventory management systems, methods, and apparatuses.

### BRIEF DESCRIPTION OF THE DRAWINGS

Disclosed herein are embodiments of systems, apparatuses, and methods pertaining to presenting information on an digital inventory preparation label (DIPL). This description includes drawings, wherein:

FIG. 1A is an isometric view of a package 102 with a digital inventory preparation label (DIPL) 104 secured to the package 102, according to some embodiments;

FIG. 1B is a front view of a digital inventory preparation label (DIPL) 104 including a display device 106 and an indicator 108, according to some embodiments;

FIG. 1C is a side view of a digital inventory preparation label (DIPL) 104 including a securement mechanism 110, according to some embodiments;

FIG. 2 is a block diagram depicting a system 200 for presenting information on a digital inventory preparation label (DIPL) 202, according to some embodiments; and

FIG. 3 is a flow chart depicting example operations for presenting information on a digital inventory preparation label (DIPL) according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to presenting information on an digital inventory preparation label (DIPL). In some embodiments, a system for presenting information on an DIPL comprises the DIPL, wherein the DIPL comprises a display device, wherein the display device is configured to present information related to an action to perform with a package assigned to the DIPL, a wireless radio, and a securement mechanism, wherein the securement mechanism is configured to removably secure the DIPL to the package assigned to the DIPL, and a control circuit, wherein the control circuit is communicatively coupled to the DIPL, the control circuit configured to receive identification information for the DIPL and information for the package assigned to the DIPL, associate, in a database, the identification information for the DIPL and the information for the package assigned to the DIPL, determine the action to perform, wherein the action to perform is based on information associated with inventory levels in a retail facility, determine, based on the association between the identification information for the DIPL and the information for the package assigned to the DIPL in the database, that the package assigned to the DIPL is required for the action, and transmit, to the DIPL for presentation via the display device of the DIPL, an indication of the information related to the action to perform with the package assigned to the DIPL.

As previously discussed, inventory management is important to retailers. For example, prompt replenishment of product display units on a salesfloor is important for maintaining and/or increasing sales, and an accurate inventory of products on hand is important for order planning. Current inventory management methods rely on manual assessment of inventory levels. While manual assessment of inventory levels can be fairly accurate, manual assessment of inventory levels is at best cumbersome and at worst costly. One particular drawback with manual inventory management is in the inability to know in real or near real time what products need to be moved from the stockroom to the sales floor. Additionally, manual inventory management requires scanning of packages to determine what actions need to be performed with the packages. For example, every morning an employee may scan every product/package in a stockroom to determine if the product/package needs to be moved to the salesfloor.

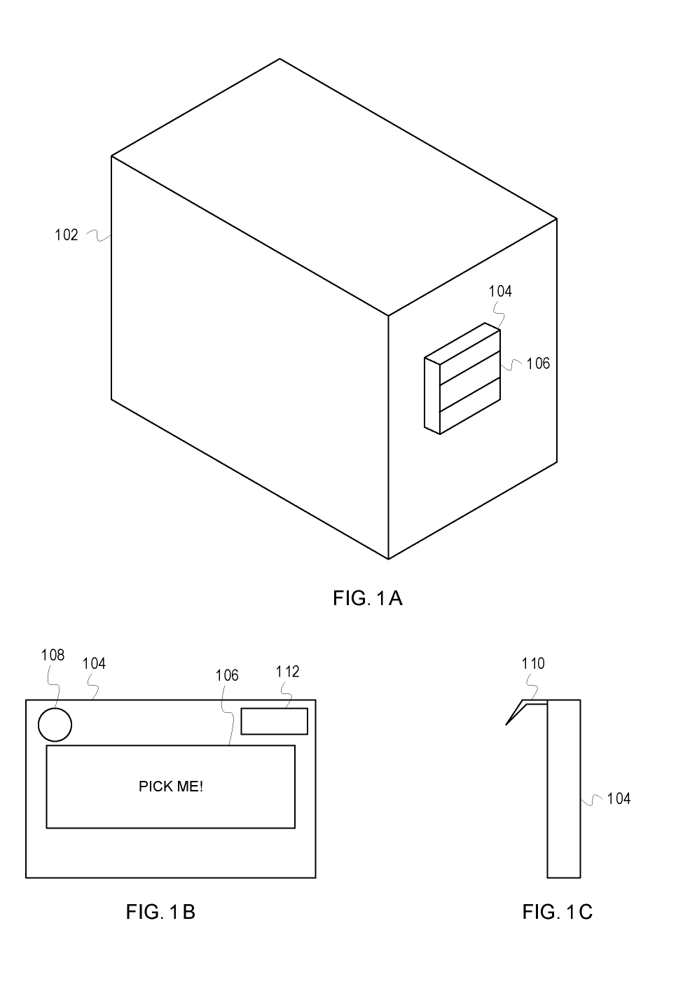

In embodiments described herein, systems, methods, and apparatuses are described that can increase the accuracy and timeliness of inventory management assessments and reduce costs associated with inventory management assessments. In some embodiments, digital inventory preparation labels (DIPLs) are placed on packages in a stockroom. The DIPLs are capable of communicating with a backend and include a display device. When a package, or the contents of a package, should be move from the stockroom to the salesfloor, the display device of the associated DIPL can present a message indicating that the package, or contents of the package, should be moved to the salesfloor. Because the DIPLs present a message indicating an action to perform with the package (e.g., move to the sales floor), employees can quickly and easily determine what to do with packages without scanning the packages. For example, when an employee enters the stockroom, he or she may notice that DIPL associated with a package indicates that the package should be moved to the salesfloor. The employee knows what to do with the package without requiring action of the employee (e.g., the employee is not required to scan the package to determine what to do with the package). The discuss of FIG. 1 provides an overview of such a system.

FIG. 1A is an isometric view of a package 102 with a digital inventory preparation label (DIPL) 104 secured to the package 102, according to some embodiments. The package 102 can be of any suitable type. For example, the package 102 can be a disposable box (e.g., cardboard, wood, etc.), a reusable box (e.g., a crate, pallet, etc.), packaging for an item (e.g., packaging for a single item used to present the item for sale), a box containing multiple items (e.g., a box containing a number of prepackaged items or items that require no packaging), etc. Additionally, the package 102 can take any shape or form. For example, the package 102 can be a box, crate, pallet, bucket, plastic wrap, paper wrap, or any other device capable of holding, covering, or securing one or more products. The DIPL 104 is secured to the package 102 and includes a display device 106. The display device 106 can take any suitable form. For example, the display device 106 can be a liquid crystal display (LCD), light emitting diode (LED) display, cathode ray tube (CRT) display, e-paper display, speakers, etc. Additionally, the display device 106 can be configured to present any suitable information. For example, the display device 106 can be configured to display text, lights, colors, sounds, etc. indicative of an action perform with the package 102. Further, the DIPL 104 can be a purpose-built device (e.g., a device designed specifically as a DIPL) or an existing device that is repurposed (e.g., an electronic shelf label (ESL)).

FIG. 1B is a front view of a digital inventory preparation label (DIPL) 104 including a display device 106 and an indicator 108, according to some embodiments. As previously noted, the display device 106 can be configured to present any suitable information. The example DIPL 104 depicted in FIG. 1B includes a display device configured to present text. As shown in FIG. 1B, the display device 106 is presenting the text “PICK ME!” Such text may indicate that the package 102 should be moved from the stockroom to the salesfloor. The display device 106 can present any information related to the package 102. For example, the display device 106 can present an indication that the package 102 should be moved to the salesfloor, that the package 102 should be moved to a new location (e.g., in the stockroom), that the contents of the package 102 are subject to a recall, that the contents of the package 102 are part of a feature, a quantity and/or type of items in the package 102, etc.

In addition to, or in lieu of, the display device 106, the DIPL 104 can include an indicator (i.e., a secondary display device) 108. Like the display device 106, the indicator 108 can be used to present information regarding the package 102 or an action to perform with the package 102. For example, the indicator 108 can be a light (e.g., an LED) configured to present different colors, patterns, etc. that indicate information about the package 102 or an action to perform with the package 102. As one example, the indicator 108 can change color based on an action to perform with the package 102. For example, the indicator 108 can illuminate red when the package 102 should remain in the stockroom and green when the package 102 should be moved to the salesfloor.

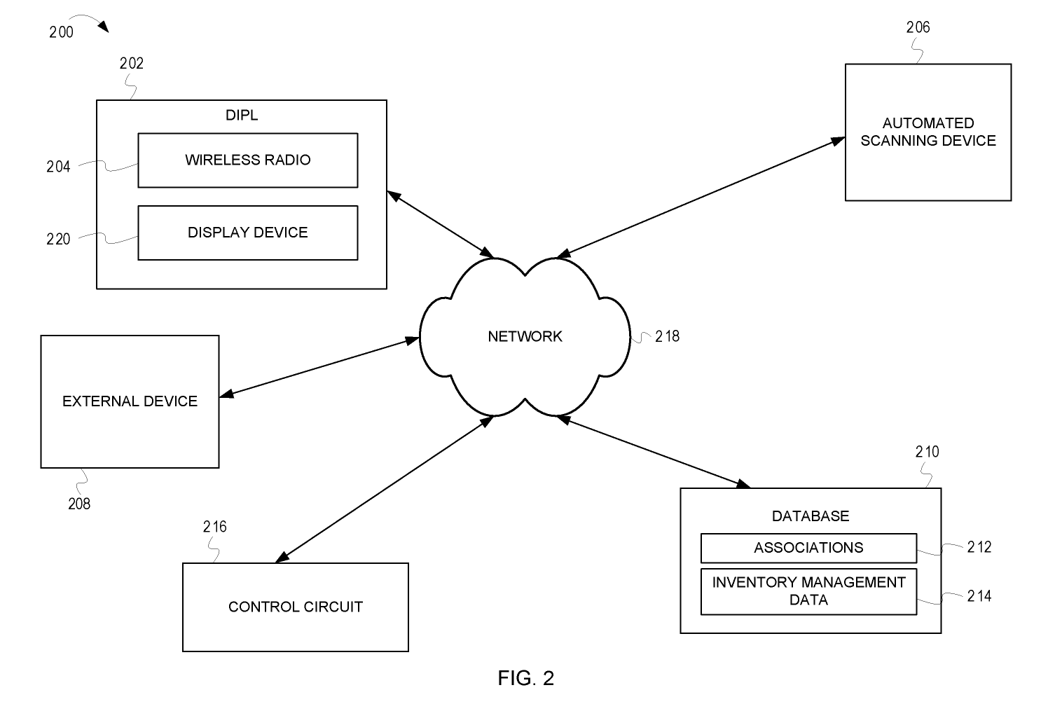

As depicted in FIG. 1B, the DIPL 104 also includes a wireless radio 112. The wireless radio 112 is configured to transmit and/or receive information related to the package 102, as described in more detail with respect to FIG. 2. For example, the wireless radio 112 can transmit information to the backend regarding identification information for the DIPL 104, information for the package 102, etc. and receive, from the backend, information relating to an action to perform with the package 102.

FIG. 1C is a side view of a digital inventory preparation label (DIPL) 104 including a securement mechanism 110, according to some embodiments. The securement mechanism 110 is configured to secure the DIPL 104 to the package 102. In some embodiments, the securement mechanism 110 is configured to removably secure the DIPL 104 to the package 102. In such embodiments, the DIPL 104 may be reusable in that it can be reassigned to a different package once its use with the package 102 is no longer required or desirable. The securement mechanism 110 can take any suitable form to permanently or removably secure the DIPL 104 to the package 102. For example, the securement mechanism 110 can include one or more of an adhesive, a clamp, a hook, a barb, a pin, a hook and loop system, a fastener, a bracket, etc. Additionally, the type of the securement mechanism 110 can vary dependent upon the type of the package 102. For example, a hook-type securement mechanism 110 may be desirable if the package 102 is made of cardboard, an adhesive-type securement mechanism 110 may be desirable if the package 102 is made of plastic, and a fastener-type securement mechanism 110 may be desirable if the package 102 is made of wood.

While the discussion of FIG. 1 provides an overview of a DIPL for use in inventory management systems, the discussion of FIG. 2 provides additional details regarding such an inventory management system.

FIG. 2 is a block diagram depicting a system 200 for presenting information on a digital inventory preparation label (DIPL) 202, according to some embodiments. The system 200 includes the DIPL 202, an external device 208, a control circuit 216, a database 210, and an automated scanning device 206. These components can communicate with one another via a network 218. The network 218 can be of any suitable type, such as the Internet, an intranet, a near field communication (NFC) network, etc. Although FIG. 2 depicts a number of components in the system, some of the components depicted in FIG. 2 may not be necessary for all embodiments.

The control circuit 216 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 216 is configured (for example, by using corresponding programming as will be well understood by those skilled in the art) to carry out one or more of the steps, actions, and/or functions described herein.

By one optional approach the control circuit 216 operably couples to a memory. The memory may be integral to the control circuit 216 or can be physically discrete (in whole or in part) from the control circuit 216 as desired. This memory can also be local with respect to the control circuit 216 (where, for example, both share a common circuit board, chassis, power supply, and/or housing) or can be partially or wholly remote with respect to the control circuit 216 (where, for example, the memory is physically located in another facility, metropolitan area, or even country as compared to the control circuit 216).

This memory can serve, for example, to non-transitorily store the computer instructions that, when executed by the control circuit 216, cause the control circuit 216 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

When packages are received at a retail facility (e.g., in a shipment), the packages are scanned. In some embodiments, as the depicted in FIG. 2, the automated scanning device 206 can scan the packages as the arrive. The automated scanning device 206 is a device capable of automatically processing packages as they are received. For example, the automated scanning device 206 can be a robot that scans packages as they are unloaded from a truck. If the system 200 does not include an automated scanning device 206, the packages can be scanned manually. In either case, the packages are scanned to determine information for the package. The information for the package can include a package identifier, an indication of the contents of the package (e.g., identifying the items in the package), an indication of a quantity of items in the package, timing information for the package (e.g., sell by dates, receipt dates, manufacture dates, etc.), location information for the package (e.g., a location in a stockroom, salesfloor, etc. for the package), or any other suitable information.

Once the package is scanned, the DIPL 202 is assigned to the package. In some embodiments, this assignment includes transmitting, to the DIPL 202, information for the package to which the DIPL 202 is assigned. For example, the automated scanning device 206, or in the case of a manual scan, a hand scanner, can transmit the information for the package to the DIPL 202.

The DIPL 202 includes a display device 220 and a wireless radio 204. The display device 220 is configured to present information related to the package. For example, the display device 220 can present information relating to an action to perform with the package. The wireless radio 204 communicates with the control circuit 216 (and possibly other components of the system 200). In one embodiment, the wireless radio 204 transmits identification information for the DIPL 202 and information for the package to the control circuit 216. The identification information for the DIPL 202 can include any information suitable for identifying the DIPL 202, such as a serial number, a media access control (MAC) address, an interne protocol (IP) address, an alphabetic, numeric, or alphanumeric identifier, radio frequency identification number if the DIPL 202 includes an RFID tag, etc.

Upon receipt of the identification information for the DIPL 202 and the information for the package, the control circuit 216 associates the identification information for the DIPL 202 and the information for the package in the database 210. These associations 212 are stored in the database 210. The associations 212 can be as simple as listing of the identification information for the DIPL 202 and an identifier for the package, as elaborate as the identification information for the DIPL 202 and the entirety of the information for the package (e.g., contents of the package, quantity of items in the package, a location for the contents of the package in the stockroom and/or on the salesfloor), or any amount of information in between. Additionally, in some embodiments, the database 210 can also include inventory management data 214. The inventory management data 214 can include point-of-sale (POS data), stock level information, shipment information, past sales information, forecasted sales information, etc. (generally referred to as information associated with inventory levels in a retail facility).

As conditions change in the retail facility (e.g., inventory levels change in the retail facility), the control circuit 216 determines an action to perform. For example, the action to perform can be stocking action, a relocation action, or any other action related to products in the retail facility. If the action to perform requires a package, the control circuit 216 can identify the package required for the action and the identification information for the DIPL 202 based on the database 210. For example, the inventory management data 214 may reflect that the number of apples on the sales floor is below a desired level. Based on the inventory management data 214, the control circuit can determine that the action to perform is to move apples from the stockroom to the salesfloor. Based on the associations 212 in the database, the DIPL 202 is associated with a package of apples. The control circuit 216 transmits (i.e., transmits or causes transmission) of an indication of information related to the action to perform with the package assigned to the DIPL 202 to the DIPL 202. In the example noted above, the control circuit 216 would transmit an indication to the DIPL that the package assigned to the DIPL 202 should be moved to the salesfloor for restocking.

Upon receipt of the indication to perform, the DIPL 202 presents the information related to the action to perform. In the example noted above, the DIPL 202 would present, via the display device 220, an indication that the package should be moved to the salesfloor for restocking. Because the determination of the action to perform is performed automatically by the control circuit 216 and the indication of the action to perform is presented via the display device 220, it is not necessary for an employee to scan the package to determine that the package should be brought to the salesfloor. Rather, an employee in the stockroom will only need to notice the information presented on the DIPL 202 to determine that the package should be brought to the salesfloor.

In addition to the control circuit 216 determining actions to perform based on information included in the database 210, in some embodiments, directions can be communicated directly to the control circuit 216 via the network 218. For example, the external device 208 can transmit instructions to the control circuit 216. As one example, the external device 208 can be a handheld device carried by an employee of the retailer. While the employee is on the salesfloor, he or she may notice that the quantity of baseball bats on the salesfloor is less than desired. The employee may then transmit, via the external device 208, an instruction to the control circuit 216 that additional baseball bats should be moved from the stockroom to the salesfloor. Responsively, the control circuit can identify the DIPL 202 associated with a package containing baseball bats in the database 210 and transmit an indication to the DIPL 202 associated with the package containing baseball bats that the package should be moved to the salesfloor. Embodiments which include the external device 208 may increase the speed with which items are restocked because it is not necessary that the items be purchased (i.e., recorded in the inventory management data 214) before determining that inventory levels for that item are low. Additionally, in some embodiments, the external device 208 can be used to fulfill specific requests. For example, if a customer desires a large number of an item, the external device 208 can transmit an instruction that the large number of the item be brought from the stockroom to the customer.

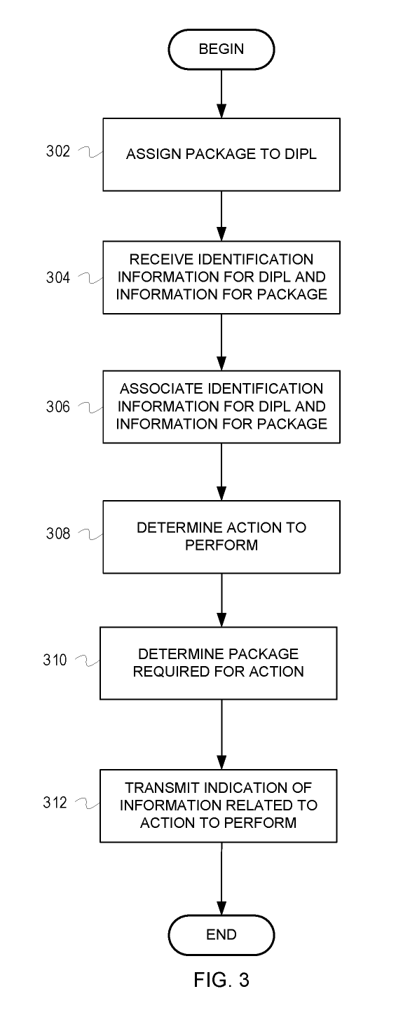

While the discussion of FIG. 2 provides additional discussion regarding a system for presenting information on a DIPL, the discussion of FIG. 3 describes example operations for presenting information on a DIPL.

FIG. 3 is a flow chart depicting example operations for presenting information on a digital inventory preparation label (DIPL) according to some embodiments. The flow begins at block 302.

At block 302, a package is assigned to a DIPL. For example, a scanning device (e.g., an automated scanning device) or a control circuit can assign a package to the DIPL. When the package is received at a retail facility, a DIPL is assigned to the package. Before, or possibly after, the DIPL is assigned to the package, the DIPL is secured to the package. The DIPL is used to present information related to the package. For example, if there is currently no action requiring the package, the DIPL can present information regarding the package, such as the contents of the package, timing information for the package, a quantity of items in the package, a location of the package, etc. Alternatively, if there is currently no action requiring the package, the DIPL can present no information (e.g., remain blank). The flow continues at block 304.

At block 304, identification information for the DIPL and information for the package are received. For example, the control circuit can receive the identification information for the DIPL and the information for the package. In some embodiments, the DIPL transmits the identification information for the DIPL and the information for the package to the control circuit via a wireless radio associated with the DIPL. In other embodiments, another device, such as a scanning device, can transmit the identification information for the DIPL and the information for the package to the control circuit. The identification information for the DIPL identifies the DIPL. Additionally, in some embodiments, the identification information for the DIPL can include addressing information for the DIPL to facilitate communication from the control circuit to the DIPL. The information for the package can include any suitable information for the package. For example, the information for the package can identify the package, contents of the package, etc. The flow continues at block 306.

At block 306, the identification information for the DIPL and the information for the package are associated. For example, the control circuit can associate the identification information for the DIPL and the information for the package in a database. The database can be specific to a retail facility, or include information for DIPLs and packages at a number of retail facilities. In some embodiments, this association allows the control circuit to quickly determine what packages, and more importantly, what items are associated with the DIPL. The flow continues at block 308.

At block 308, an action to perform is determined. For example, the control circuit can determine the action to perform. The action can be a stocking action, a feature action, a modular action, a recall action, or any other suitable action. In some embodiments, the control circuit determines the action perform based on information associated with inventory levels in the retail facility. The inventory levels in the retail facility can include inventory levels in the stockroom, inventory levels on the sales floor, shipment information, POS data, sales prediction data, etc. The flow continues at block 310.

At block 310, it is determined that the action to perform requires the package. For example, the control circuit can determine that the action to perform requires the package. In some embodiments, this determination is made based on the associations in the database. For example, the action to perform requires jeans, the control circuit can determine that Package A contains jeans and that DIPL X is assigned to Package A. Further, in some embodiments, if multiple packages contain the same items but one of the multiple packages should be selected first, DIPLs associated with others of the multiple packages can present indications that they should not be picked. This can be particularly useful for perishable items, ensuring that the oldest items are retrieved first. the flow continues at block 312.

At block 312, an indication of information related to the action to perform is transmitted. For example, the control circuit can transmit the indication of information related to the action to perform to the DIPL. The information related to the action to perform can be any suitable information, such as a message stating the information related to the action to perform. In the example noted above, the control circuit transmits the indication of the action to perform to DIPL X. The DIPL presents the information related to the action to perform. If the action to perform is a stocking action, DIPL X presents a stocking message via a display device.

In some embodiments, a system for presenting information on an DIPL comprises the DIPL, wherein the DIPL comprises a display device, wherein the display device is configured to present information related to an action to perform with a package assigned to the DIPL, a wireless radio, and a securement mechanism, wherein the securement mechanism is configured to removably secure the DIPL to the package assigned to the DIPL, and a control circuit, wherein the control circuit is communicatively coupled to the DIPL, the control circuit configured to receive identification information for the DIPL and information for the package assigned to the DIPL, associate, in a database, the identification information for the DIPL and the information for the package assigned to the DIPL, determine the action to perform, wherein the action to perform is based on information associated with inventory levels in a retail facility, determine, based on the association between the identification information for the DIPL and the information for the package assigned to the DIPL in the database, that the package assigned to the DIPL is required for the action, and transmit, to the DIPL for presentation via the display device of the DIPL, an indication of the information related to the action to perform with the package assigned to the DIPL.

In some embodiments, an apparatus and a corresponding method performed by the apparatus comprises assigning, to the DIPL, a package assigned to the DIPL, wherein the DIPL includes a display device configured to present information related to an action to perform with the package assigned to the DIPL, a wireless radio, and a securement mechanism configured to removably secure the DIPL to the package assigned to the DIPL, receiving, at a control circuit, identification information for the DIPL and information for the package assigned to the DIPL, associating, by the control circuit in a database, the identification information for the DIPL and the information for the package assigned to the DIPL, determining, by the control circuit, an action to perform, wherein the action to perform is based on inventory levels in a retail facility, determining, by the control circuit based on the association between the identification information for the DIPL and the information for the package assigned to the DIPL in the database, that the package assigned to the DIPL is required for the action, and transmitting, to the DIPL for presentation via the display device of the DIPL, an indication of the information related to the action to perform with the package assigned to the DIPL.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for presenting information on an digital inventory preparation label (DIPL), the system comprising:
the DIPL, wherein the DIPL comprises:
a display device, wherein the display device is configured to present information related to an action to perform with a package assigned to the DIPL;
a wireless radio; and
a securement mechanism, wherein the securement mechanism is configured to removably secure the DIPL to the package assigned to the DIPL; and
a control circuit, wherein the control circuit is communicatively coupled to the DIPL, the control circuit configured to:
receive identification information for the DIPL and information for the package assigned to the DIPL;
associate, in a database, the identification information for the DIPL and the information for the package assigned to the DIPL;
determine the action to perform, wherein the action to perform is based on information associated with inventory levels in a retail facility;
determine, based on the association between the identification information for the DIPL and the information for the package assigned to the DIPL in the database, that the package assigned to the DIPL is required for the action; and
transmit, to the DIPL for presentation via the display device of the DIPL, an indication of the information related to the action to perform with the package assigned to the DIPL.

2. The system of claim 1, wherein the action to perform is a restocking action, and wherein the information related to the action to perform with the package assigned to the DIPL is a statement that contents of the package assigned to the DIPL should be moved to a salesfloor.

3. The system of claim 1, wherein the action to perform is determined based on one or more of point-of-sale (POS) data, a manual request, an automated request, and a predicted need.

4. The system of claim 1, wherein the information for the package assigned to the DIPL includes one or more of an identifier of the package assigned to the DIPL, contents of the package assigned to the DIPL, a location of the package assigned to the DIPL, a quantity of items in the package assigned to the DIPL, and timing information for the package assigned to the DIPL.

5. The system of claim 1, wherein the action to perform is a set feature action, and wherein the information related to the action to perform with the package assigned to the DIPL is a statement that the package assigned to the DIPL includes associated with a feature to be set.

6. The system of claim 1, further comprising an automated scanning device, wherein the automated scanning device is configured to:
automatically scan the package assigned to the DIPL; and
assign the package to the DIPL.

7. The system of claim 1, wherein the database includes associations between multiple DIPLs and information for packages assigned to the multiple DIPLs.

8. The system of claim 1, wherein the action to perform is a back-stocking action, and wherein the information related to the action to perform with the package assigned to the DIPL is a statement that the package assigned to the DIPL should be stored in a stockroom.

9. The system of claim 8, wherein the statement that the package assigned to the DIPL should be stored in a stockroom includes a location within the stockroom.

10. The system of claim 1, wherein the securement mechanism is one or more of an adhesive, a clamp, a hook, a barb, a pin, a hook and loop system, a fastener, and a bracket.

11. A method for presenting information on an digital inventory preparation label (DIPL), the method comprising:
assigning, to the DIPL, a package assigned to the DIPL, wherein the DIPL includes a display device configured to present information related to an action to perform with the package assigned to the DIPL, a wireless radio, and a securement mechanism configured to removably secure the DIPL to the package assigned to the DIPL;
receiving, at a control circuit, identification information for the DIPL and information for the package assigned to the DIPL;
associating, by the control circuit in a database, the identification information for the DIPL and the information for the package assigned to the DIPL;
determining, by the control circuit, an action to perform, wherein the action to perform is based on inventory levels in a retail facility;
determining, by the control circuit based on the association between the identification information for the DIPL and the information for the package assigned to the DIPL in the database, that the package assigned to the DIPL is required for the action; and
transmitting, to the DIPL for presentation via the display device of the DIPL, an indication of the information related to the action to perform with the package assigned to the DIPL.

12. The method of claim 11, wherein the action to perform is a restocking action, and wherein the information related to the action to perform with the package assigned to the DIPL is a statement that contents of the package assigned to the DIPL should be moved to a salesfloor.

13. The method of claim 11, wherein the action to perform is determined based on one or more of point-of-sale (POS) data, a manual request, an automated request, and a predicted need.

14. The method of claim 11, wherein the information for the package assigned to the DIPL includes one or more of an identifier of the package assigned to the DIPL, contents of the package assigned to the DIPL, a location of the package assigned to the DIPL, a quantity of items in the package assigned to the DIPL, and timing information for the package assigned to the DIPL.

15. The method of claim 11, wherein the action to perform is a set feature action, and wherein the information related to the action to perform with the package assigned to the DIPL is a statement that the package assigned to the DIPL includes associated with a feature to be set.

16. The method of claim 11, further comprising:
automatically scanning, by an automated scanning device, the package assigned to the DIPL, wherein the automated scanning device assigns the package assigned to the DIPL to the DIPL.

17. The method of claim 11, wherein the database includes associations between multiple DIPLs and information for packages assigned to the multiple DIPLs.

18. The method of claim 11, wherein the action to preform is a back-stocking action, and wherein the information related to the action to perform with the package assigned to the DIPL is a statement that the package assigned to the DIPL should be stored in a stockroom.

19. The method of claim 18, wherein the statement that the package assigned to the DIPL should be stored in a stockroom includes a location within the stockroom.

20. The method of claim 11, wherein the securement mechanism includes one or more of an adhesive, a clamp, a hook, a barb, a pin, a hook and loop system, a fastener, and a bracket.
